(19) United States
(12) Patent Application Publication
(10) Pub. No.: US 2013/0168893 A1
(43) Pub. Date: Jul. 4, 2013

(54) CHARGING OF FILTER MEDIA

(71) Applicants: Sudhakar Jaganathan, Waltham, MA (US); Cameron Thomson, Charleston, SC (US)

(72) Inventors: Sudhakar Jaganathan, Waltham, MA (US); Cameron Thomson, Charleston, SC (US)

(73) Assignee: Hollingsworth & Vose Company, East Walpole, MA (US)

(21) Appl. No.: 13/339,686

(22) Filed: Dec. 29, 2011

(51) Int. Cl. B29C 67/20

(52) U.S. Cl. 264/85; 264/101

(57) ABSTRACT

Methods and systems for charging fiber webs, including those suitable for use as filter media, are provided. In some embodiments, the methods provided herein involve charging a fiber web by passing a substance through the web under suitable conditions to produce a charged article. The substance may be, for example, a substantially non-polar liquid or gas, a compressed fluid, and/or a supercritical fluid (e.g., carbon dioxide). In some embodiments, the method of charging includes releasing the substance from a container, passing the substance through the fiber web, and, optionally, drawing the substance into a vacuum apparatus after it passes through the fiber web.

### FIELD OF INVENTION

The present invention relates to methods of charging fiber webs, such as fiber webs suitable for use as filter media, and systems related thereto.

### BACKGROUND OF INVENTION

Filter media can be used to remove contamination in a variety of applications. In some cases, the filter media is formed of a web of fibers. The fiber web provides a porous structure that permits a fluid (e.g., a gas or a liquid) to flow through the filter media. Contaminant particles contained within the fluid may be trapped on the fibrous web. Depending on the application, the filter media may be designed to have different characteristics. Filter media characteristics such as charge, flow resistance, surface area, and basis weight affect filter performance including filter efficiency. It is known in the art that efficiency of the filter media can be increased by charging the media by methods such as corona charging, triboelectric charging, hydrocharging, or other electret charging methods. However, certain existing charging methods may be slow, may require long drying times (resulting in increased manufacturing costs), and/or may damage the media. Methods of charging that address these and other issues would be beneficial.

### SUMMARY OF INVENTION

Methods and systems for charging fiber webs, including those suitable for use as filter media, are provided.

In one set of embodiments, a series of methods are provided. In one embodiment, a method of charging a fiber web is provided. The method involves providing a source of a substantially non-polar substance, wherein the substantially non-polar substance is held in a container that includes a mechanism for releasing the substantially non-polar substance from the container. The method further involves releasing the substantially non-polar substance from the container and passing the substantially non-polar substance through a fiber web from a first side to a second side of the fiber web. The method includes drawing at least a portion of the substantially non-polar substance into a vacuum apparatus positioned at the second side of the fiber web.

In another embodiment, a method of charging a fiber web comprises providing a source of carbon dioxide and passing the carbon dioxide through a fiber web from a first side to a second side of the fiber web. The method involves drawing at least a portion of the carbon dioxide into a vacuum apparatus positioned at the second side of the fiber web, wherein the fiber web is exposed to the atmosphere during the passing step.

In another embodiment, a method of charging a fiber web comprises transporting a fiber web across a charging apparatus, wherein the charging apparatus comprises a source of a substantially non-polar substance, the substantially non-polar substance being held in a container that includes a mechanism for releasing the substantially non-polar substance from the container. The method involves releasing the substantially non-polar substance from the container and passing the substantially non-polar substance through a fiber web from a first side to a second side of the fiber web during the transporting step.

Other aspects, embodiments, advantages and features of the invention will become apparent from the following detailed description.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows an exemplary method and apparatus for charging a fiber web according to one set of embodiments; and

FIGS. 2A-2G show various nozzle designs according to one set of embodiments.

### DETAILED DESCRIPTION

Methods and systems for charging fiber webs, including those suitable for use as filter media, are provided. In some embodiments, the methods provided herein involve charging a fiber web by passing a substance through the web under suitable conditions to produce a charged article. The substance may be, for example, a substantially non-polar liquid or gas, a compressed fluid, and/or a supercritical fluid (e.g., carbon dioxide). In some embodiments, the method of charging includes releasing the substance from a container, passing the substance through the fiber web, and, optionally, drawing the substance into a vacuum apparatus after it passes through the fiber web.

Without wishing to be bound by theory, it is believed that charging takes place while a substance passes across the fiber web due to, at least in part, the triboelectric effect. As known to those of ordinary skill in the art, triboelectric charging is a type of contact electrification in which materials become electrically charged after they come into contact with a different material, and after which the materials are separated. The strength of the charges produced in a material may vary according to the differences in dielectric constant between the material used to form the fiber web and the substance being passed through the fiber web. It is generally believed that, all other parameters being equal, the greater difference in dielectric constant of the two materials, the greater amount of charge is transferred to the fiber web.

In certain existing charging methods, substances that are polar and have a high dielectric constant, such as water, have been used to produce charged articles. Specifically, for the charging of fiber webs to be used as filter media, it is generally believed that the use of polar substances lead to better charging and/or filter media having higher efficiencies compared to the use of non-polar substances. However, some such processes may have drawbacks such as long drying times after the charging process.

For instance, since water has a relatively low vapor pressure, longer drying times, higher temperatures, and/or more energy may be required to remove residual water from the fiber web after the charging process, compared to when fluids having a relatively higher vapor pressure are used. By contrast, certain methods described herein for forming charged fiber webs can be performed without long drying times, at relatively low temperatures, and/or with less use of energy for drying. In some embodiments, the methods described herein involve the use of particular substances, such as substantially non-polar substances, to promote triboelectric charging. In some cases, the charging methods described herein involve relatively low differences in dielectric constant between the material used to form the fiber web and the substance being passed through the fiber web. In certain embodiments, such methods may involve a particular configuration of components of a charging apparatus. In some embodiments, such methods may involve charging under particular conditions that promote charging, such as the pressure at which a substance is released from a container. Combinations of such methods are also provided.

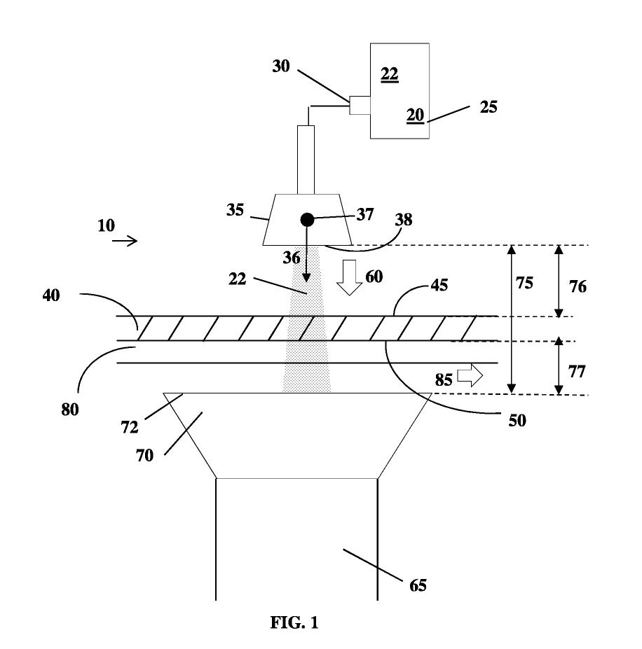

An example of a charging apparatus and process is shown in the embodiment illustrated in FIG. 1. As shown illustratively in FIG. 1, a charging apparatus can include a source 20 of a substance 22 to be passed across a fiber web to facilitate charging. The substance may be held in a container 25 (e.g., a gas tank) having a particular volume for holding the substance. The container may include a mechanism 30, such as a valve, for releasing the substance from the container. The container may be connected to a nozzle 35 (e.g., via tubing) for directing the substance towards a fiber web 40.

As shown illustratively in FIG. 1, the fiber web may include a first side 45 and a second side 50. The first side of the fiber web may be exposed to the nozzle such that substance 22, when it is released from the container and exits the nozzle in the direction of arrow 60, impinges the first side of the fiber web. Because the fiber web is porous, the substance can pass across the fiber web from the first side to the second side. The fiber web may be exposed to the atmosphere while the substance passes across it.

In some embodiments, a vacuum apparatus 65 may be positioned facing the second side of the fiber web. The vacuum apparatus may include a vacuum slot 70 which, in some embodiments, may be positioned underneath nozzle 35. The vacuum apparatus may facilitate the passing of the substance across the fiber web by drawing the substance into the vacuum apparatus at a suitable rate. In some embodiments, this positioning of the vacuum slot with respect to the nozzle can result in a fiber web having a relatively high charge by, for instance, increasing the velocity at which the substance passes across the fiber web and increasing the triboelectric effect. A distance 75 between a nozzle lip 38 and a top 72 portion of the vacuum slot, a distance 76 between the nozzle lip and first side 45 (e.g., a top surface) of the fiber web, and/or a distance 77 between the top portion of the vacuum slot and second side 50 (e.g., a bottom surface) of the fiber web may be varied to control the amount of charging.

As shown illustratively in FIG. 1, the fiber web may be positioned on a support 80. In some cases, the support is stationary while the substance passes across the fiber web. In other cases, the support is moving during the passing step. For example, the support may be a wire, a belt, or other suitable component for transporting the fiber web across the charging apparatus.

It should be appreciated that all components shown in FIG. 1 need not be present in certain embodiments. For example, in some cases a charging apparatus need not include a vacuum apparatus. As another example, in some cases container 25 need not include a mechanism for releasing the substance from the container.

In other embodiments, the position of certain components of the charging apparatus may differ than the configuration shown in FIG. 1. For example, the vacuum apparatus need not be positioned directly underneath the nozzle, and may be positioned, for instance, downstream of the nozzle (e.g., in the direction of arrow 85) or upstream of the nozzle. As another example, the positioning of the nozzle and vacuum apparatus in FIG. 1 may be reversed, e.g., such that the nozzle is positioned underneath the vacuum apparatus and the substance impinges the second side of the fiber web. In other embodiments, a first nozzle may be positioned above the fiber web as shown in FIG. 1 (e.g., for passing a substance through the fiber web from the first side to the second side of the fiber web) and a second nozzle may be positioned below the fiber web (e.g., for passing a substance through the fiber web from the second side to the first side of the fiber web). Passing of the substances (which may be the same or different) using the first and second nozzles may be performed simultaneously or sequentially. Optionally, first and second vacuum apparatuses may be associated with the first and second nozzles, respectively, in such an embodiment.

Furthermore, in yet other embodiments, components that are not shown in FIG. 1 may be present in a charging apparatus. For example, although a single container 25 is shown in FIG. 1, in other embodiments, a charging apparatus may include more than one container, each container containing the same or a different substance. Multiple containers may be used, for example, for forming a mixture of substances that passes across a fiber web. In other embodiments, multiple containers may be connected to multiple nozzles that are aligned in series in the direction of arrow 85 for passing multiple substances across a fiber web in series. In another example, one or more vacuum slots may be positioned on a drum which may rotate with respect to the fiber web. In yet other embodiments, an ultrasonic horn, which may vibrate the fiber web by exposing the fiber web to ultrasonic energy, may be used in place of a vacuum apparatus for facilitating the passage of the substance through the fiber web. The ultrasonic horn may be positioned at any suitable position with respect to the nozzle and/or fiber web, such as the positions described herein for the vacuum apparatus. Other components and/or configurations are also possible.

The apparatus shown in FIG. 1 may be positioned at any suitable location with respect to other fiber web or filter media systems. For example, in some embodiments, the apparatus shown in FIG. 1 may be positioned downstream of a system for forming a fiber web (e.g., a meltblown, electrospinning, or spunbonding system).

The source of the substance in the container, the substance as it is released from the container or nozzle, and/or the substance as it passes across the fiber web, may have any suitable form or phase, e.g., it may comprise a gas, a liquid, and/or a solid. Substances in a solid phase may be present as solid particles. In some embodiments, a mixture of more than one phase may be present. For example, a mixture may include a substance, a portion of which is in a gaseous phase and a portion of which is in a liquid phase. In other instances, a mixture may include a substance, a portion of which is in a gaseous phase and a portion of which is in a solid phase. In yet other instances, a mixture may include a substance, a portion of which is in a liquid phase and a portion of which is in a solid phase. In some embodiments, a substance may be in a supercritical state, as described in more detail below.

In certain embodiments, a change in phase of the substance may occur while the substance is transported from a first location to a second location within the charging apparatus (e.g., from the container to the fiber web). For example, the source of the substance in the container may be a liquid (e.g., liquid carbon dioxide), and the liquid may convert to a gas (e.g., gaseous carbon dioxide) and/or a solid (e.g., solid carbon dioxide particles or dry ice) as the substance is released from the container or nozzle. Although all of a substance may change phases in some cases, in other cases, portions but not all of the substance may change phases as it is transported, e.g., released from the container or nozzle. In other embodiments, the source of the substance may have a particular phase (e.g., a gas, liquid or solid) and the phase of the substance does not substantially change as the substance is released from the container or nozzle. The particular phase of a substance may be varied by, for example, controlling the environment in which the substance is placed, such as the temperature and pressure in the container as well as the temperature and pressure at which the substance is released from the container or nozzle towards the fiber web.

The substance used to charge a fiber web may have any suitable chemical composition. In some embodiments, source 20 of a substance, substance 22 as it is released from the container or nozzle, and/or substance 22 as it passes across the fiber web may be substantially non-polar. A substantially non-polar substance may have a Debye length of less than 0.5. Non-limiting examples of substantially non-polar substances include carbon dioxide, oxygen gas, hydrogen gas, argon, nitrogen gas, helium, neon, xenon, methane, fluorine gas, nitrous oxide, and air. In some cases, the substantially non-polar substance is an inert gas. Mixtures of substantially non-polar substances are also possible. The non-polar substances in a mixture may be of the same phase or different phases.

It should be appreciated that while much of the description provided herein describes substantially non-polar substances, in some embodiments polar substances (e.g., substances having a Debye length of greater than 0.5, greater than 1.0, greater than 1.5, or greater than 2.0) may be used.

In some embodiments, one or more polar substances may be used alone or in combination with one or more substantially non-polar substances. In some such embodiments, a mixture may include greater than or equal to about 20 wt % greater than or equal to about 40 wt %, greater than or equal to about 60 wt %, greater than or equal to about 80 wt %, greater than or equal to about 90 wt %, greater than or equal to about 95 wt %, or greater than or equal to about 98 wt % of the one or more substantially non-polar substances, with the remaining portions of the mixture being one or more polar substances. In some embodiments, a mixture may include less than about 98 wt %, less than about 95 wt %, less than about 80 wt %, less than about 60 wt %, less than about 40 wt %, or less than about 20 wt % of the one or more substantially non-polar substances, with the remaining portions of the mixture being one or more polar substances. Other percentages are also possible. Combinations of the above-noted ranges are also possible (e.g., a mixture having greater than or equal to about 60 wt % and less than about 98 wt % of a substantially non-polar substance). The mixture, if present, may be any one of a mixture in a container, a mixture as it is released from the container or nozzle, a mixture as it passes across the fiber web, or combinations thereof.

A substance (e.g., in a container, as it is released from a container or nozzle, and/or as it passes across the fiber web) may have any suitable triple point. The triple point of a substance is the temperature and pressure at which the three phases (liquid, gas, and solid) of the substance coexist in thermodynamic equilibrium. Triple points of various substances are known. For example, the triple point for acetylene is 192.4K, for argon is 83.8K, for carbon dioxide is 216.55K, for ethane is 89.89K, for ethylene is 104.0K, for helium is 2.19K, for hydrogen is 13.84K, for methane is 90.68K, for nitrogen is 63.18K, for oxygen is 54.36K, and for water is 273.16K.

In some embodiments, a substance used to charge a fiber web as described herein has a triple point of less than about 268K (−5° C.), less than about 263K (−10° C.), less than about 258K (−15° C.), less than about 243K (−30° C.), less than about 223K (−50° C.), less than about 198K (−75° C.), less than about 173K (−100° C.), less than about 148K (−125° C.), less than about 123K (−150° C.), or less than about 73K (−200° C.). In some embodiments, the triple point of a substance used to charge a fiber web may be greater than or equal to about 73K (−200° C.), greater than or equal to about 123K (−150° C.), greater than or equal to about 148K (−125° C.), greater than or equal to about 173K (−100° C.), greater than or equal to about 198K (−75° C.), greater than or equal to about 223K (−50° C.), greater than or equal to about 243K (−30° C.), greater than or equal to about 258K (−15° C.), greater than or equal to about 263K (−10° C.), or greater than or equal to about 268K (−5° C.). Other ranges of triple point are also possible. Combinations of the above-noted ranges are also possible (e.g., a substance having a triple point of greater than or equal to about 223K (−50° C.) and less than about 268K (−5° C.)).

A substance (e.g., in a container, as it is released from a container or nozzle, and/or as it passes across the fiber web) may have any suitable boiling point. In some embodiments, a substance may have a boiling point of less than about 373K (100° C.), less than about 348K (75° C.), less than about 323K (50° C.), less than about 298K (25° C.), less than about 273K (0° C.), less than about 268K (−5° C.), less than about 263K (−10° C.), less than about 258K (−15° C.), less than about 243K (−30° C.), less than about 223K (−50° C.), less than about 198K (−75° C.), less than about 173K (−100° C.), less than about 148K (−125° C.), less than about 123K (−150° C.), or less than about 73K (−200° C.). In certain embodiments, a substance has a boiling point of greater than or equal to about 73K (−200° C.), greater than or equal to about 123K (−150° C.), greater than or equal to about 148K (−125° C.), greater than or equal to about 173K (−100° C.), greater than or equal to about 198K (−75° C.), greater than or equal to about 223K (−50° C.), greater than or equal to about 243K (−30° C.), greater than or equal to about 258K (−15° C.), greater than or equal to about 263K (−10° C.), or greater than or equal to about 268K (−5° C.), greater than or equal to about 273K (0° C.), greater than or equal to about 298K (25° C.), greater than or equal to about 323K (50° C.), greater than or equal to about 348K (75° C.), or greater than or equal to about 373K (100° C.). Other ranges of boiling point are also possible. Combinations of the above-noted ranges are also possible (e.g., a substance having a boiling point of greater than or equal to about 223K (−50° C.) and less than about 373K (100° C.)).

In some embodiments, a substance (e.g., in a container, as it is released from a container or nozzle, and/or as it passes across the fiber web) may be a supercritical fluid. A supercritical fluid is a substance at a temperature and pressure above its critical point, where distinct liquid and gas phases do not exist. As such, supercritical fluids may have properties between those of a gas and a liquid. A variety of different materials can be used as supercritical fluids in the method described herein. Non-limiting examples of materials include carbon dioxide, water, methane, ethane, propane, ethylene, propylene, methanol, ethanol, and acetone. In some embodiments, a substance may be in a supercritical state during only a portion of a process described herein. For example, a substance may be a supercritical fluid in container 25 of FIG. 1. As the supercritical fluid is released from the container and/or the nozzle, the environment in which the fluid is contained may be changed such that the phase of the substance changes and the substance is no longer considered a supercritical fluid. In some such embodiments, the substance may convert to a gas, a solid, a liquid, and/or a combination thereof during such a process. As such, the substance may have a different phase as it passes across the fiber web during the charging process compared to its initial state.

In some embodiments, a substance may be a compressed fluid (i.e., a subcooled fluid or subcooled liquid). A compressed fluid is a fluid under thermodynamic conditions that force it to be a liquid, i.e., a liquid at a temperature lower than the saturation temperature at a given pressure. The compressed fluid may have a boiling point or a triple point described herein or may be contained in a container at a pressure described herein.

In some embodiments, a substance may be a cryogenic fluid. A cryogenic fluid is a fluid at a very low temperature (e.g., below about 123K (−150° C.)). Non-limiting examples of fluids that may be cryogenic fluids include helium, hydrogen, neon, nitrogen, oxygen, and air.

In some cases, a substance may be a noble gas. Non-limiting examples of noble gases include helium, neon, argon, krypton, and xenon.

In one set of embodiments, a substance (e.g., in a container, as it is released from a container or nozzle, and/or as it passes across the fiber web) comprises an organic compound. The organic compound may be, for example, a chlorofluorocarbon (CFC) or a hydrochlorofluorocarbon (HCFC). Specific examples of CFCs include trichlorofluoromethane, dichlorodifluoromethane, chlorotrifluoromethane, chlorodifluoromethane, dichlorofluoromethane, chlorofluoromethane, bromochlorodifluoromethane, 1,1,2-trichloro-1,2,2-trifluoroethane, 1,1,1-trichloro-2,2,2-trifluoroethane, 1,2-dichloro-1,1,2,2-tetrafluoroethane, 1-chloro-1,1,2,2,2-pentafluoroethane, 2-chloro-1,1,1,2-tetrafluoroethane, 1,1-dichloro-1-fluoroethane, 1-chloro-1,1-difluoroethane, tetrachloro-1,2-difluoroethane, tetrachloro-1,1-difluoroethane, 1,1,2-Trichlorotrifluoroethane, 1-bromo-2-chloro-1,1,2-trifluoroethane, 2-bromo-2-chloro-1,1,1-trifluoroethane, 1,1-dichloro-2,2,3,3,3-pentafluoropropane, and 1,3-dichloro-1,2,2,3,3-pentafluoropropane.

The difference between the dielectric constant of the material used to form the fiber web and the dielectric constant of the substance used during the charging process may vary. Dielectric constants of different materials are known. For example, water has a dielectric constant of ˜80 at 20° C., liquid carbon dioxide has a dielectric constant of ˜1.6, polyethylene has a dielectric constant of ˜2.2 at room temperature, and polypropylene has a dielectric constant of ˜2.2-2.36 at room temperature. In some embodiments, the difference between the dielectric constant of the material used to form the fiber web and the dielectric constant of the substance used during the charging process may be less than or equal to about 80, less than or equal to about 60, less than or equal to about 40, less than or equal to about 20, less than or equal to about 10, less than or equal to about 5, less than or equal to about 3, less than or equal to about 1.0, less than or equal to about 0.5 (e.g., under the conditions used for charging). In some embodiments, the difference in dielectric constants may be greater than or equal to about 0.1, greater than or equal to about 0.5, greater than or equal to about 1.0, greater than or equal to about 3, greater than or equal to about 5, greater than or equal to about 10, greater than or equal to about 20, greater than or equal to about 40, greater than or equal to about 60, or greater than or equal to about 80. Other differences in dielectric constants are also possible. Combinations of the above-noted ranges are also possible (e.g., a substance/material combination having a difference in dielectric constant that is less than or equal to about 20 and greater than or equal to about 0.1). When mixtures of substances are used for charging and/or when more than one material is used to form a fiber web, one or more substance/material combination, or each substance/material combination, may have a difference in dielectric constant in a range noted above.

As shown illustratively in FIG. 1, source 20 of a substance may be held in a container having a particular volume. A container may have any suitable volume. In some embodiments, a container may have a volume of greater than or equal to about 0.5 L, greater than or equal to about 1 L, greater than or equal to about 5 L, greater than or equal to about 10 L, greater than or equal to about 20 L, greater than or equal to about 50 L, or greater than or equal to about 100 L. In some embodiments, the volume of a container is less than about 100 L, less than about 50 L, less than about 20 L, less than about 10 L, less than about 5 L, or less than about 0.5 L. Other volumes are also possible. Combinations of the above-noted ranges are also possible (e.g., a volume of greater than or equal to about 0.5 L and less than about 20 L).

In some cases, the container is pressurized such that the source of the substance is held in the container at a pressure above atmospheric pressure. In some cases, the substance is held in the container at a pressure of greater than or equal to about 5 psi, greater than or equal to about 25 psi, greater than or equal to about 50 psi, greater than or equal to about 75 psi, greater than or equal to about 100 psi, greater than or equal to about 150 psi, greater than or equal to about 200 psi, greater than or equal to about 300 psi, or greater than or equal to about 500 psi. In certain cases, the substances held in the container at a pressure of less than about 700 psi, less than about 500 psi, less than about 300 psi, less than about 200 psi, less than about 100 psi, or less than about 50 psi. Other values of pressure are also possible. Combinations of the above-noted pressures are also possible (e.g., a pressure of greater than or equal to about 50 psi and less than about 700 psi, greater than or equal to about 25 psi and less than about 500 psi, or greater than or equal to about 50 psi and less than about 200 psi). In other embodiments, the container is not pressurized and the substance is contained at atmospheric pressure.

The substance may be released from the container at any suitable pressure. In some cases, the substance is released from the container at atmospheric pressure. In other embodiments, the substance is released from the container at a pressure of greater than atmospheric pressure, greater than or equal to about 5 psi, greater than or equal to about 25 psi, greater than or equal to about 50 psi, greater than or equal to about 75 psi, greater than or equal to about 100 psi, greater than or equal to about 150 psi, greater than or equal to about 200 psi, greater than or equal to about 300 psi, or greater than or equal to about 500 psi. In certain cases, the substances is released from the container at a pressure of less than about 700 psi, less than about 500 psi, less than about 300 psi, less than about 200 psi, less than about 100 psi, or less than about 50 psi. Other values of pressure are also possible. Combinations of the above-noted pressures are also possible (e.g., a substance released at a pressure of greater than or equal to about 25 psi and less than about 500 psi). The pressure at which a substance is released from a container may be measured at an outlet of the container using a pressure gauge operatively associated with mechanism 30 (e.g., a valve) used for releasing the substance from the container.

A substance may be held in a container at any suitable temperature. In some cases, a substance may be held in a container at a temperature of less than about 373K (100° C.), less than about 348K (75° C.), less than about 323K (50° C.), less than about 298K (25° C.), less than about 273K (0° C.), less than about 268K (−5° C.), less than about 263K (−10° C.), less than about 258K (−15° C.), less than about 243K (−30° C.), less than about 223K (−50° C.), less than about 198K (−75° C.), less than about 173K (−100° C.), less than about 148K (−125° C.), less than about 123K (−150° C.), or less than about 73K (−200° C.). In some embodiments, the temperature at which a substance is held in a container is greater than or equal to about 73K (−200° C.), greater than or equal to about 123K (−150° C.), greater than or equal to about 148K (−125° C.), greater than or equal to about 173K (−100° C.), greater than or equal to about 198K (−75° C.), greater than or equal to about 223K (−50° C.), greater than or equal to about 243K (−30° C.), greater than or equal to about 258K (−15° C.), greater than or equal to about 263K (−10° C.), greater than or equal to about 268K (−5° C.), greater than or equal to about 273K (0° C.), greater than or equal to about 298K (25° C.), greater than or equal to about 323K (50° C.), greater than or equal to about 348K (75° C.), or greater than or equal to about 373K (100° C.). Other ranges of temperature are also possible. Combinations of the above-noted ranges are also possible (e.g., a substance held in a container at a temperature of greater than or equal to about 223K (−50° C.) and less than about 298K (25° C.)).

As shown in the embodiment illustrated in FIG. 1, a vacuum apparatus may be positioned such that after substance 22 is released from the nozzle and passes through the fiber web, it is drawn directly into the vacuum. The vacuum apparatus may be set at any appropriate vacuum level. In some cases, the vacuum level may be greater than or equal to about 1 inches of mercury, greater than or equal to about 5 inches of mercury, greater than or equal to about 7 inches of mercury, greater than or equal to about 10 inches of mercury, greater than or equal to about 12 inches of mercury, greater than or equal to about 15 inches of mercury, greater than or equal to about 18 inches of mercury, greater than or equal to about 20 inches of mercury, greater than or equal to about 25 inches of mercury, or greater than or equal to about 28 inches of mercury. In some embodiments, the vacuum level is less than about 29 inches of mercury, less than about 25 inches of mercury, less than about 20 inches of mercury, less than about 18 inches of mercury, less than about 15 inches of mercury, less than about 12 inches of mercury, less than about 10 inches of mercury, less than about 7 inches of mercury, less than about 5 inches of mercury, or less than about 2 inches of mercury. Other vacuum levels are also possible. Combinations of the above-noted values are also possible (e.g., a vacuum level of greater than or equal to about 7 inches of mercury and less than about 15 inches of mercury).

Although much of the description herein describes the use of a vacuum apparatus for facilitating passage of a substance through a fiber web, it should be appreciated that in some embodiments, no such apparatus is needed. In other embodiments, an apparatus other than a vacuum apparatus may be used to facilitate the passage of a substance through a fiber web. One such example is an ultrasonic horn. An ultrasonic horn may be used to deliver ultrasonic energy to the fiber web, causing the fiber web to vibrate, thereby facilitating the passage of a substance through the pores of the web. The ultrasonic horn may be positioned, for example, on the same side of the fiber web as the nozzle, or opposite the nozzle. Other apparatuses for facilitating the passage of a substance through a fiber web are also possible.

As shown illustratively in FIG. 1, distance 75 between a nozzle lip 38 and a top 72 portion of the vacuum slot (or other apparatus, such as an ultrasonic horn) may be varied to control the amount of charging. In some embodiments, the distance between the nozzle lip and the vacuum slot (or other apparatus) is between about 0.5 inches and about 30 inches. The distance may be, for example, less than or equal to about 30 inches, less than or equal to about 20 inches, less than or equal to about 15 inches, less than or equal to about 12 inches, less than or equal to about 10 inches, less than or equal to about 8 inches, less than or equal to about 6 inches, less than or equal to about 4 inches, less than or equal to about 2 inches, or less than or equal to about 1 inch. In some embodiments, the distance may be greater than about 0.5 inches, greater than about 1 inch, greater than about 2 inches, greater than about 4 inches, greater than about 6 inches, greater than about 8 inches, greater than about 10 inches, greater than about 12 inches, greater than about 15 inches, greater than about 20 inches, or greater than about 25 inches. Other distances are also possible. Combinations of the above-noted distances are also possible (e.g., a distance of less than or equal to about 15 inches and greater than about 1 inch).

Similarly, a distance 76 between nozzle lip 38 and first side 45 of the fiber web and/or a distance 77 between the vacuum slot (or other apparatus) and second side 50 of the fiber web may be varied to control the amount of charging. In some embodiments, one or both of these distances is between about 0.5 inches and about 30 inches. The distance may be, for example, less than or equal to about 30 inches, less than or equal to about 20 inches, less than or equal to about 15 inches, less than or equal to about 12 inches, less than or equal to about 10 inches, less than or equal to about 8 inches, less than or equal to about 6 inches, less than or equal to about 4 inches, less than or equal to about 2 inches, or less than or equal to about 1 inch. In some embodiments, one or both of these distances may be greater than about 0.5 inches, greater than about 1 inch, greater than about 2 inches, greater than about 4 inches, greater than about 6 inches, greater than about 8 inches, greater than about 10 inches, greater than about 12 inches, greater than about 15 inches, greater than about 20 inches, or greater than about 25 inches. Other distances are also possible. Combinations of the above-noted distances are also possible (e.g., a distance of less than or equal to about 15 inches and greater than about 1 inch).

In embodiments in which at least a portion of the substance released from a container or nozzle is drawn into the vacuum apparatus, any suitable amount of the substance may be collected. In some embodiments, greater than or equal to 20%, greater than or equal to 40%, greater than or equal to 50%, greater than or equal to 60%, greater than or equal to 80%, or greater than or equal to 90% of the substance released from the container or nozzle may be drawn into the vacuum apparatus. In some embodiments, less than 100%, less than 95%, less than 90%, less than 80%, less than 60%, less than 40%, or less than 20% of the substance released from the container or nozzle may be drawn into the vacuum apparatus. Other amounts are also possible. Combinations of the above-noted ranges are also possible (e.g., greater than or equal to 50% and less than 100% of the substance released from the container or nozzle may be drawn into the vacuum apparatus). The substance drawn into the vacuum may be recycled in some embodiments.

The angle of the nozzle with respect to the surface of the fiber web may also be varied. The angle of the nozzle may be determined using a center line of the nozzle. As shown illustratively in FIG. 1, the center line of the nozzle refers to an imaginary line 36 in the general direction of flow through the nozzle that intersects a geometric center 37 of the nozzle. In some embodiments, a center line of the nozzle is substantially perpendicular to the surface of the fiber web. In other embodiments, the center line of the nozzle may be positioned at an angle of less than or equal to 90°, less than or equal to 75°, less than or equal to 60°, less than or equal to 45°, less than or equal to 30°, or less than or equal to 15° with respect to the surface of the fiber web. In some embodiments, the center line of the nozzle may be positioned at an angle of greater than 0°, greater than 15°, greater than 30°, greater than 45°, greater than 60°, or greater than 75° with respect to the surface of the fiber web. Other angles are also possible. Combinations of the above-noted ranges are also possible (e.g., an angle of greater than 45° and less than or equal to 90° with respect to the surface of the fiber web).

As described above, in some embodiments fiber web 40 of FIG. 1 may be positioned on a support that may move across the charging apparatus during the charging process. Advantageously, the charging methods described herein may be performed at relatively high speeds, resulting in relatively high rates of formation of the charged web. In some cases, the support may be moving, e.g., during the charging process, at a speed of greater than or equal to about 0.1 ft/min, greater than or equal to about 1 ft/min, greater than or equal to about 5 ft/min, greater than or equal to about 10 ft/min, greater than or equal to about 15 ft/min, greater than or equal to about 20 ft/min, greater than or equal to about 30 ft/min, greater than or equal to about 50 ft/min, greater than or equal to about 75 ft/min, greater than or equal to about 100 ft/min, greater than or equal to about 150 ft/min, greater than or equal to about 200 ft/min, greater than or equal to about 300 ft/min, greater than or equal to about 400 ft/min. In some embodiments, the support may be moving, e.g., during the charging process, at a speed of less than about 400 ft/min, less than about 300 ft/min, less than about 200 ft/min, less than about 150 ft/min, less than about 100 ft/min, less than about 75 ft/min, less than about 50 ft/min, less than about 30 ft/min, less than about 20 ft/min, less than about 15 ft/min, less than about 10 ft/min, less than about 5 ft/min, less than about 1 ft/min, or less than about 0.1 ft/min. Other speeds are also possible. Combinations of the above-noted ranges are also possible (e.g., a speed of greater than or equal to about 5 ft/min and less than about 15 ft/min).

In some embodiments, a fiber web may be passed across a charging apparatus multiple times to charge a fiber web. For example, a fiber web may be passed across a charging apparatus at least 2, at least 3, at least 4, at least 5, at least 6, at least 7, or at least 8 times. In some embodiments, both a first side and a second side of the fiber web may be exposed to the nozzle during the passing steps. For example, a first side of the fiber web may be exposed to the nozzle during a first passing step, and then the second side of the article may be exposed to the nozzle during a second passing step. Alternating the first and second sides to be exposed to the nozzle during the passing step may produce a fiber web having a relatively uniform charge across the fiber web.

Charging may be performed at any suitable humidity level. In some cases, charging is performed at a humidity level of greater than or equal to about 5 RH %, greater than or equal to about 10 RH %, greater than or equal to about 20 RH %, greater than or equal to about 40 RH %, greater than or equal to about 60 RH %, greater than or equal to about 80 RH %, greater than or equal to about 90 RH %, or at about 100 RH %. In some cases, the humidity level is less than about 100 RH %, less than about 85 RH %, less than about 60 RH %, less than about 40 RH %, less than about 20 RH %, less than about 10 RH %, or less than about 5 RH %. Other humidity levels are also possible. Combinations of the above-noted ranges are also possible (e.g., a humidity level of greater than or equal to about 20 RH % and less than about 85 RH %).

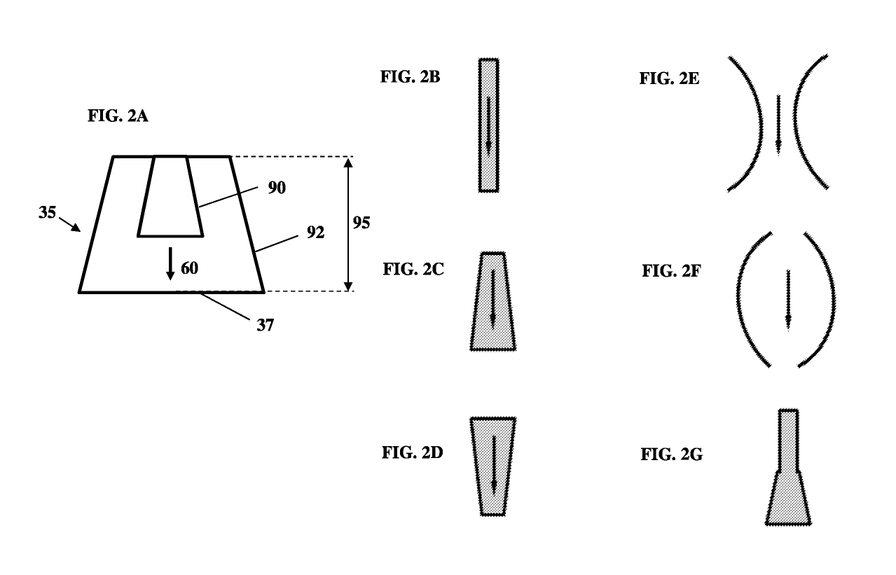

A charging apparatus may include any suitable nozzle 35 for releasing a substance. Examples of nozzles having different shapes are shown illustratively in FIGS. 2A-2G. As shown in FIG. 2A, in some embodiments, nozzle 35 includes a primary nozzle 90 and a secondary nozzle 92. The primary nozzle may be inserted into all or portions of the secondary nozzle, which may be used to change the trajectory of the substance as it exits the nozzle. In some cases, the primary nozzle is connected to a flow extension tube (not shown) which extends into the secondary nozzle. A flow extension tube may be used to vary the distance of the primary nozzle with respect to a height 95 of the nozzle and/or nozzle lip 38. In other embodiments, nozzle 35 includes only a primary nozzle.

As shown illustratively in FIG. 2A, the primary and secondary nozzles may have similar designs and are both designed to diverge the flow of a substance as it exits the nozzle in the direction of arrow 60. In other embodiments, the primary and secondary nozzles may have different designs. Examples of nozzle designs are shown illustratively in FIGS. 2B-2G. FIG. 2B shows a nozzle having a constant width or area along its height. FIG. 2C show a nozzle having a diverging design. FIG. 2D shows a nozzle having a converging design. FIG. 2E shows a nozzle having a converging-diverging design. FIG. F shows a nozzle having a diverging-converging design. FIG. G shows a nozzle having a venturi configuration. Other nozzle types are also possible. Each of the designs shown in FIGS. 2B-2G may be suitable for a primary and/or a secondary nozzle as various combinations of designs may be used.

A nozzle (e.g., a primary and/or secondary nozzle) may also include additional components in some embodiments. For example, a nozzle may be connected to a heating source (e.g., a heating jacket) which may help avoid the buildup of any solids (e.g., ice) inside the orifice of a nozzle. Other components are also possible.

A nozzle may be formed of any suitable material. In some embodiments, a nozzle is formed primarily of a thermally conductive material. Non-limiting examples of such materials may include metals such as steel, brass, copper, and aluminum. In other embodiments, a nozzle is formed primary of a thermally insulating material. In some cases, a nozzle comprises a polymer. Non-limiting examples of suitable polymers may include polycarbonate, PTFE, and polyolefins.

In some embodiments, a fiber web to be charged by the charging method and apparatus shown in FIG. 1 is uncharged. In other embodiments, the fiber web is first charged by a first charging process, and then subjected to a second charging process, e.g., the charging method described with respect to FIG. 1. In yet other embodiments, the fiber web is first charged by the method described with respect to FIG. 1, and then subjected to a second charging method. Advantageously, a fiber web that is charged by two different processes may, in some embodiments, result in an electret article having a higher amount of charge and/or having a more permanent charge than a fiber web charged by a single process.

Additional charging can be effected by, for example, the use of AC and/or DC corona discharge units and combinations thereof. The particular characteristics of the discharge are determined by the shape of the electrodes, the polarity, the size of the gap, and the gas or gas mixture. Charging can also be accomplished using other techniques, including friction-based charging techniques.

As described herein, an electrostatic charge can be imparted to a fiber web which may be used in a filter media. Charge may be imparted to various layers of the media. For example, a charge may be imparted to a filtration layer (e.g., a fine fiber filtration layer) prior to joining with one or more coarse support layers. In another embodiment, a charge is imparted to a filter media including more than one layer, e.g., a fine fiber filtration layer and one or more coarse support layers. Depending on the materials used to form each of the layers, the amount of charge, and the method of charging, the charge may either remain in one or more of the layers or dissipate after a short period of time (e.g., within hours).

It should be understood that while fiber webs in the form of filter media are primarily described herein, the articles and methods herein are not so limited and may find use in other applications. Accordingly, other articles may have one or more of the characteristics described herein.

The methods described herein may have advantages over certain existing methods for charging fiber webs. For example, as noted above, hydrocharging processes, which involve the use of water to charge an article, typically require relatively long drying times to remove residual water from the article after the drying process. In some embodiments, methods described herein using substances (e.g., substantially non-polar substances, non-aqueous fluids, or other substances described herein) may require no or less energy needed to dry the fiber web after the charging process. For instance, in some embodiments, a fiber web that is charged by a method described herein may be further processed (e.g., collected onto a roll) without a further drying process. In other embodiments, a lower drying time and/or a lower drying temperature is needed to remove any residual substances from the fiber web. The fiber web may, for example, be subjected to a drying process for less than 10 minutes, less than 8 minutes, less than 6 minutes, less than 5 minutes, less than 4 minutes, less than 3 minutes, less than 2 minutes, or less than 1 minute. The drying process may include, for example, the use of a drying vacuum, a drying oven, or other drying methods known in the art.

If a drying process is used in conjunction with a method described herein, drying may take place at a temperature of, for example, less than about 100° C., less than or equal to about 90° C., less than about 80° C., less than about 70° C., less than about 60° C., less than about 40° C., or less than about 20° C. In some embodiments, drying may take place at a temperature of greater than or equal to about 20° C., greater than or equal to about 40° C., greater than or equal to about 60° C., or greater than or equal to about 80° C. Other drying temperatures are also possible. Combinations of the above-noted ranges are also possible (e.g., drying at a temperature of less than about 70° C. and greater than or equal to about 20° C.).

The methods described herein have additional advantages over certain existing methods for charging articles. Other methods for charging articles, such as corona charging processes, are also known. Under certain conditions (e.g., low humidity, higher basis weight media, and/or higher voltages), corona charging processes may result in spark discharges. When spark discharge occurs in the process of charging fiber webs, holes may be produced in the fiber web. The methods described herein do not result in spark discharge; therefore, unwanted holes in the fiber web are avoided.

The charged fiber web or filter media described herein may be characterized by several properties. Penetration, often expressed as a percentage, is defined as follows:

Pen=C/C₀

where C is the particle concentration in the fluid after passage through the fiber web or filter media and C₀ is the particle concentration in the fluid before passage through the fiber web or filter media.

In some embodiments, a fiber web or filter media described herein has a penetration value between about 0.0001% and about 90%. For example, the fiber web or filter media may have a penetration value of greater than or equal to about 0.0001, greater than or equal to about 0.001%, greater than or equal to about 0.01%, greater than or equal to about 0.1%, greater than or equal to about 1%, greater than or equal to about 5%, greater than or equal to about 10%, greater than or equal to about 20%, greater than or equal to about 40%, greater than or equal to about 60%, or greater than or equal to about 80%. In some embodiments, a fiber web or filter media may have a penetration value less than or equal to about 90%, of less than or equal to about 80%, less than or equal to about 60%, less than or equal to about 40%, less than or equal to about 20%, less than or equal to about 10%, less than or equal to about 1%, less than or equal to about 0.1%, less than or equal to about 0.01%, or less than or equal to about 0.001%. Other values of penetration are also possible. Combinations of the above-noted ranges are also possible (e.g., a fiber web or filter media having a penetration value of greater than or equal to about 0.0001% and less than or equal to about 1%).

Typical tests of penetration involve blowing NaCl (sodium chloride) particles through a fiber web or filter media and measuring the percentage of particles that penetrate through the fiber web or filter media. Penetration values described herein are determined using an 8130 CertiTest™ automated filter testing unit from TSI, Inc. equipped with a sodium chloride generator. The average particle size created by the salt particle generator is 0.26 micron mass mean diameter. The instrument measures a pressure drop (i.e., flow resistance) across the fiber web and the resultant penetration value on an instantaneous basis at a flow rate less than or equal to 115 L/min. The 8130 can be run in an instantaneous mode. All penetration values described herein were determined using a 23 mg loading of NaCl particles and subjecting the upstream face of a fiber web to an airflow of 32 L/min over a 100 cm² face area of the fiber web, giving a media face velocity of 5.3 cm/s.

The flow resistance, also known as pressure drop, across the fiber web or filter media is measured based on the above NaCl penetration tests. The resistance across the fiber web or filter media may vary depending on the particular application of the filter media. In some embodiments, the overall resistance across the fiber web or filter media may be between about 0.02 mm H₂O and about 42 mm H₂O. In some cases, the overall resistance may be greater than or equal to about 0.02 mm H₂O, greater than or equal to about 0.1 mm H₂O, greater than or equal to about 1 mm H₂O, greater than or equal to about 5 mm H₂O, greater than or equal to about 10 mm H₂O, greater than or equal to about 20 mm H₂O, greater than or equal to about 30 mm H₂O, or greater than or equal to about 40 mm H₂O. In some cases, the overall resistance may be less than about 40 mm H₂O, less than about 30 mm H₂O, less than about 20 mm H₂O, less than about 10 mm H₂O, less than about 5 mm H₂O, less than about 1 mm H₂O, or less than about 0.1 mm H₂O. Other values of resistance are also possible.

The values of resistance described herein were determined using the same instrument and test conditions for measuring penetration.

Advantageously, the methods described herein can produce charged fiber webs or filter media having a greater efficiency compared to fiber webs or filter media that are not subjected to the charging methods described herein. In some embodiments, an uncharged fiber web or filter media may require a relatively high basis weight, or may have a low basis weight but may require a relatively high resistance, to achieve a given filtration efficiency (e.g., as a greater amount of fiber is needed to mechanically capture particles). By charging a fiber web or filter media using the methods described herein, the fiber web or filter media includes an electrostatic force which attracts particles more efficiently so that a fiber web or filter media having a relatively lower basis weight, lower amounts of fiber, and/or a relatively lower resistance can be used to achieve the same efficiency.

Filter efficiency is defined as:

100-% Penetration

Because it may be desirable to rate fiber web or filter medias based on the relationship between penetration and resistance (or pressure drop) across the web or media, or efficiency as a function of pressure drop across the web or media, filters may be rated according to a value termed “gamma value”. Generally, higher gamma values are indicative of better filter performance, i.e., a high efficiency as a function of pressure drop. Gamma value is expressed according to the following formula:

gamma=(−log(NaCl penetration %/100)/resistance, mm H₂O)×100

which is equivalent to:

gamma=(−log(NaCl penetration %/100)/resistance, Pa)×100×9.8.

As discussed above, the NaCl penetration percentage is based on the percentage of particles that penetrate through the fiber web or filter media. With decreased NaCl penetration percentage (i.e., increased efficiency) where particles are less able to penetrate through the fiber web or filter media, gamma increases. With decreased resistance to fluid flow across the filter (i.e., low pressure drop across the filter), gamma increases. These generalized relationships between NaCl penetration, resistance/pressure drop, and/or gamma assume that the other properties remain constant.

The fiber web or filter media described herein may have relatively high values of −log(NaCl penetration %/100)/resistance, mm H₂O)×100; that is, high gamma values. In some embodiments, the value of (−log(NaCl penetration %/100)/resistance, mm H₂O)×100 for the fiber web or filter media is greater than or equal to about 12, greater than or equal to about 15, greater than or equal to about 20, greater than or equal to about 30, greater than or equal to about 40, greater than or equal to about 60, greater than or equal to about 80, greater than or equal to about 100, greater than or equal to about 120, greater than or equal to about 140, greater than or equal to about 160, or greater than or equal to about 180. In some embodiments, the gamma value is less than about 200, less than about 180, less than about 160, less than about 140, less than about 120, less than about 100, less than about 80, less than about 60, less than about 40, or less than about 20. Other values of gamma are also possible. Combinations of the above-noted ranges are also possible (e.g., a gamma value of greater than or equal to about 20 and less than about 100). Gamma is calculated based on measurements taken of a fiber web or filter media subject to the NaCl penetration and resistance tests described herein.

The surface area of the fiber web or filter media may vary depending on the particular application and method of use of the web or media. The surface area may be, for example, less than about 1.8 m²/g, less than about 1.6 m²/g, less than about 1.4 m²/g, less than about 1.2 m²/g, less than about 1.1 m²/g, less than about 1.0 m²/g, less than about 0.8 m²/g, less than about 0.6 m²/g, less than about 0.5 m²/g, less than about 0.4 m²/g, or less than about 0.2 m²/g. In some embodiments, the surface area may be greater than or equal to about 0.1 m²/g, greater than or equal to about 0.4 m²/g, greater than or equal to about 0.6 m²/g, greater than or equal to about 0.8 m²/g, greater than or equal to about 1.0 m²/g, greater than or equal to about 1.2 m²/g, greater than or equal to about 1.4 m²/g, greater than or equal to about 1.6 m²/g, or greater than or equal to about 1.8 m²/g. Other values of surface area are also possible. Combinations of the above-noted ranges are also possible (e.g., a fiber web having a surface area of greater than or equal to about 0.6 m²/g and less than about 1.8 m²/g).

As determined herein, surface area is measured through use of a standard BET surface area measurement technique. The BET surface area is measured according to section 10 of Battery Council International Standard BCIS-03A, “Recommended Battery Materials Specifications Valve Regulated Recombinant Batteries”, section 10 being “Standard Test Method for Surface Area of Recombinant Battery Separator Mat”. Following this technique, the BET surface area is measured via adsorption analysis using a BET surface analyzer (e.g., Micromeritics Gemini II 2370 Surface Area Analyzer) with nitrogen gas; the sample amount is between 0.5 and 0.6 grams in a ¾″ tube; and, the sample is allowed to degas at 75° C. for a minimum of 3 hours.

In some embodiments, the overall basis weight of the fiber web or filter media may range from between about 0.1 grams per square meter (gsm) and about 1000 gsm. In some embodiments, the basis weight may be less than or equal to about 1000 gsm, less than or equal to about 500 gsm, less than or equal to about 400 gsm, less than or equal to about 300 gsm, less than or equal to about 200 gsm, less than or equal to about 100 gsm, less than or equal to about 80 gsm, less than or equal to about 50 gsm, less than or equal to about 30 gsm, less than or equal to about 20 gsm, or less than or equal to about 10 gsm. In some embodiments, the basis weight may be greater than about 0.1 gsm, greater than about 1 gsm, greater than about 10 gsm, greater than about 20 gsm, greater than about 40 gsm, greater than about 60 gsm, greater than about 80 gsm, greater than about 100 gsm, greater than about 150 gsm, greater than about 200 gsm, greater than about 300 gsm, greater than about 400 gsm, or greater than about 500 gsm. Other values of basis weight are also possible. Combinations of the above-noted ranges are also possible (e.g., a fiber web having a basis weight of greater than about 1 gsm and less than or equal to about 200 gsm). between about 1 gsm and about 500 gsm, between about 1 gsm and about 200 gsm, between about 25 gsm and about 150 gsm, or between about 22 gsm and about 85 gsm. As determined herein, the basis weight of a fiber web or filter media is measured according to ASTM D 6242. The values are expressed in grams per square meter or pounds per 3,000 square feet. Basis weight can generally be measured on a laboratory balance that is accurate to 0.1 grams. A preferred size is 9 inches by 9 inches of area.

In some embodiments, the overall thickness of the fiber web or filter media may range from between about 100 microns and about 5000 microns. The overall thickness of the fiber web or filter media may be, for example, greater than about 100 microns, greater than about 200 microns, greater than about 600 microns, greater than about 800 microns, greater than about 1500 microns, or greater than about 2000 microns. In some embodiments, the thickness is less than or equal to about 5000 microns, less than or equal to 2000 microns, less than or equal to about 1500 microns, less than or equal to about 800 microns, less than or equal to about 600 microns, or less than or equal to about 200 microns. Other thicknesses are also possible. Combinations of the above-noted ranges are also possible (e.g., a thickness of greater than about 100 microns and less than or equal to about 2000 microns). As determined herein, the thickness is measured according to TAPPI Standard T411. Following this technique, a motorized caliper gauge TMI gage 49-70 can be used which has a pressure foot of 0.63 inch (16.0 mm) diameter and exerts a load of 0.3 psi (2 kPa).

The solidity of a fiber web of filter media can vary. In some embodiments, the solidity of a fiber web or filter media is greater than or equal to about 0.01%, greater than or equal to about 0.1%, greater than or equal to about 1%, greater than or equal to about 10%, greater than or equal to about 20%, greater than or equal to about 40%, greater than or equal to about 60%, or greater than or equal to about 80%. In certain embodiments, the solidity of a fiber web or filter media is less than about 80%, less than about 60%, less than about 40%, less than about 25%, less than about 20%, less than about 15%, less than about 10%, or less than about 5%. Other values of solidity are also possible. Combinations of the above-noted ranges are also possible (e.g., a solidity of greater than about 0.1% and less than about 25%).

A fiber web or filter media described herein may include fibers having any suitable diameter. In some embodiments, a fiber web may be formed of fibers having an average diameter of less than or equal to about 100 microns, less than or equal to about 80 microns, less than or equal to about 60 microns, less than or equal to about 40 microns, less than or equal to about 20 microns, less than or equal to about 10 microns, less than or equal to about 5 microns, less than or equal to about 2 microns, less than or equal to about 1.5 microns, less than or equal to about 1.4 microns, less than or equal to about 1.3 microns, less than or equal to about 1.2 microns, less than or equal to about 1.1 microns, less than or equal to 1 micron, less than or equal to about 0.8 microns, or less than or equal to about 0.6 microns. In some embodiments, the average fiber diameter of a fiber web may be greater than about 0.05 microns, greater than about 0.2 microns, greater than about 0.3 microns, greater than about 0.4 microns, greater than about 0.5 microns, greater than about 1 micron, greater than about 5 microns, greater than about 10 microns, greater than about 20 microns, greater than about 40 microns, greater than about 60 microns, or greater than about 80 microns. Other values of average fiber diameter are also possible. Combinations of the above-noted ranges are also possible (e.g., an average fiber diameter of less than or equal to 50 microns and greater than about 0.1 microns). Fiber diameters may be measured using scanning electron microscopy.

In some embodiments, a fiber web or filter media includes synthetic fibers. Synthetic fibers may be, for example, binder fibers, bicomponent fibers (e.g., bicomponent binder fibers) and/or staple fibers. In general, the synthetic fibers may have any suitable composition. Non-limiting examples of materials that can be used to form synthetic fibers include rayon, aramide, polyolefins (e.g., polyethylene, polypropylene, polybutylene, and copolymers thereof), polytetrafluoroethylene, polyesters (e.g., polyethylene terephthalate, polyvinyl acetate, polyvinyl chloride acetate, polyvinyl butyral), acrylic resins (e.g., polyacrylate, and polymethylacrylate, polymethylmethacrylate), polyamides, nylon, polyvinyl chloride, polyvinylidene chloride, polystyrene, polyvinyl alcohol, polyurethanes, cellulosic or regenerated cellulosic resins (e.g., cellulosic nitrate, cellulosic acetate, cellulosic acetate butyrate, ethyl cellulose), and copolymers of the above materials. It should be appreciated that other suitable synthetic fibers may also be used. In some cases, the synthetic fibers comprise a thermoplastic polymer. The synthetic fiber may have a resistivity of, for example, greater than about 10¹⁰ ohm·cm.

In one set of embodiments, a fiber web includes one or more bicomponent fibers. The bicomponent fibers may comprise a thermoplastic polymer. Each component of the bicomponent fiber can have a different melting temperature. For example, the fibers can include a core and a sheath where the activation temperature of the sheath is lower than the melting temperature of the core. This allows the sheath to melt prior to the core, such that the sheath binds to other fibers in the layer, while the core maintains its structural integrity. The core/sheath binder fibers can be concentric or non-concentric. Other exemplary bicomponent fibers can include split fiber fibers, side-by-side fibers, and/or “island in the sea” fibers.

Fibers may be formed using various other techniques known in the art, including wet laid techniques, air laid techniques, carding, meltblowing, electrospinning, and spunbonding.

A fiber web or filter media may include a binder resin, which may include a binder and optionally one or more additives or other components described herein. In certain embodiments, a binder forms at least 60%, at least 70%, or at least 80% of the total dry weight of the binder resin, the remaining portion being formed of one or more additives or other components.

The binder, if present in the fiber web or filter media, typically comprises a small weight percentage of the filter media. For example, the binder may comprise less than about 20% (e.g., between 2% and 20%, between 10% and 20%), less than about 10% (e.g., between 2% and 10%, between 5% and 10%), or less than about 5% (e.g., between 2% and 5%) of the total dry weight of the fiber web or filter media. In some embodiments, the binder coats the fibers and is used to adhere fibers to each other to facilitate adhesion between the fibers.

In general, the binder may have any suitable composition. In some embodiments, the binder is resin-based. In other embodiments, the binder is in the form of a binder fiber. In yet other embodiments, the binder includes a combination of a binder resin and a binder fiber. The binder fibers may form any suitable amount of the binder. For example, binder fibers may form greater than or equal to about 10%, greater than or equal to about 20%, greater than or equal to about 40%, greater than or equal to about 60%, or greater than or equal to about 80% of the total dry weight of the binder. In some cases, binder fibers form from about 10% to about 90%, from about 20% to about 80%, or from about 20% to about 60% of the total dry weight of the binder. Other percentages and ranges are also possible.

The binder may be in the form of one or more components. In some embodiments, the binder includes a soft binder and a hard binder. Though, it should be understood that not all embodiments include all of these components (e.g., hard binder) and that other appropriate binders may be used.

In addition to the binder, additional components, the fiber web, filter media, or other article may include a variety of other suitable additives (typically, in small weight percentages) such as surfactants, coupling agents, crosslinking agents, amongst others.

It should be appreciated that the fiber web, filter media, or other article may include more than one layer, e.g., at least 2, at least 3, at least 4, or at least 6 layers. Additional layers may also be included. Furthermore, all or some of the layers may be the same or different.

It should be appreciated that a fiber web, filter media, or other article may have varying values or ranges of penetration, resistance, gamma value, basis weight, thickness, and surface area, such as those values and ranges described herein, depending upon the requirements of a desired application. Furthermore, one or more of a binder, or other component can be included in the filter media or article in various combinations and amounts, such as the amounts or ranges described herein, to tailor the properties or performance characteristics of the fiber web or article.

The fiber web, filter media, or other articles may be produced using processes based on known techniques. As noted above, the fiber web or filter media can be produced using nonwoven production techniques. Thus, the fiber web or filter media may include a nonwoven web in some embodiments. In some cases, the fiber web or filter media are produced using a wet laid processing technique.

Different layers of fiber webs may be combined to produce filter media based on desired properties. Two or more layers may be added together using other processes such as lamination, co-pleating, or collation (i.e., placing two layers directly adjacent one another and keeping the layers together by pressure).

After formation, the fiber web or filter media may be further processed according to a variety of known techniques. For example, a filter media may be pleated and used in a pleated filter element. In some embodiments, filter media, or various layers thereof, may be suitably pleated by forming score lines at appropriately spaced distances apart from one another, allowing the filter media to be folded. It should be appreciated that any suitable pleating technique may be used.

The filter media may be incorporated into a variety of suitable filter elements for use in various applications including gas and liquid filtration. Filter media suitable for gas filtration may be used for ASHRAE, HEPA, and ULPA filtration applications. For example, the filter media may be used in heating and air conditioning ducts. In another example, the filter media may be used for respirator and face mask applications (e.g., surgical face masks, industrial face masks and industrial respirators). In some embodiments, certain filter media described herein are used in applications where high efficiency is desired. The filter media may also be used in combination with other filters as a pre-filter, for example, acting as a pre-filter for high efficiency filter applications (e.g., HEPA). Filter elements may have any suitable configuration as known in the art including bag filters and panel filters.

In some cases, the filter element includes a housing that may be disposed around the filter media. The housing can have various configurations, with the configurations varying based on the intended application. In some embodiments, the housing may be formed of a frame that is disposed around the perimeter of the filter media. For example, the frame may be thermally sealed around the perimeter. In some cases, the frame has a generally rectangular configuration surrounding all four sides of a generally rectangular filter media. The frame may be formed from various materials, including for example, cardboard, metal, polymers, or any combination of suitable materials. The filter elements may also include a variety of other features known in the art, such as stabilizing features for stabilizing the filter media relative to the frame, spacers, or any other appropriate feature.

As noted above, in some embodiments, the filter media can be incorporated into a bag (or pocket) filter element. A bag filter element may be formed by any suitable method, e.g., by placing two filter media together (or folding a single filter media in half), and mating three sides (or two if folded) to one another such that only one side remains open, thereby forming a pocket inside the filter. In some embodiments, multiple filter pockets may be attached to a frame to form a filter element. It should be understood that the filter media and filter elements may have a variety of different constructions and the particular construction depends on the application in which the filter media and elements are used. In some cases, a substrate may be added to the filter media.

The filter elements may have the same property values as those noted above in connection with the fiber web or filter media. For example, the above-noted penetration values, resistance values, gamma values, surface area values, basis weight values, thicknesses, solidity values and/or fiber diameters may also be found in filter elements.

### EXAMPLES

The following non-limiting examples describe fibers webs that have been made according to aspects discussed herein.

### Example 1

### Effect of CO₂ Charging Process Variables on Gamma

This example shows the effect of various charging process variables including CO₂ release pressure, belt speed, nozzle lip to vacuum slot distance (DCD), and resistance on penetration and the gamma value. The gamma value was used as an indication of the amount of charge on the fiber web, as gamma generally increases with an increase in charge.

The samples were uncharged meltblown fiber webs (handsheets) formed of polypropylene fibers having an average fiber diameter of about 2 microns. The samples had a basis weight of 25 gsm and a thickness of 8 mils. The samples were passed once through a CO₂ charging apparatus having a configuration substantially similar to that shown in FIG. 1. After CO₂ spray treatment, the samples were dried at 70° C. for 3 minutes. Results of the experiments are shown in Table 1.

TABLE 1
Effect of CO2 Charging Process Variables on Gamma

| | CO₂ | | | | | |
|---|---|---|---|---|---|---|
| | Release | Belt | | | | |
| | Pressure | Speed | DCD | Resistance | Penetration | |
| | (psi) | (ft/min) | (inches) | (mm H₂O) | (%) | Gamma |
| Control | | | | 2.7 | 67.0 | 6.1 |
| Expt 1 | 50 | 10 | 3.5 | 2.1 | 14.9 | 39.4 |
| Expt 2 | 100 | 10 | 3.5 | 2.2 | 18.0 | 33.9 |
| Expt 3 | 50 | 20 | 3.5 | 2.2 | 24.3 | 28.0 |
| Expt 4 | 100 | 20 | 3.5 | 2.2 | 21.0 | 30.9 |
| Expt 5 | 50 | 10 | 10 | 2.2 | 42.4 | 16.9 |
| Expt 6 | 100 | 10 | 10 | 2.1 | 24.5 | 28.7 |
| Expt 7 | 50 | 20 | 10 | 2.2 | 50.5 | 13.5 |
| Expt 8 | 100 | 20 | 10 | 2.2 | 28.4 | 25.1 |
| Expt 9 | 75 | 15 | 6.75 | 2.2 | 26.7 | 26.1 |

As shown in Table 1, CO₂ spraying results in a considerable increase in gamma value of the fiber web compared to the control sample which was uncharged. Major contributions to an increase in gamma value and a decrease in penetration value were the CO₂ release pressure and the DCD. Generally, a shorter DCD resulted in an increase gamma value and decreased penetration value (e.g., compare Expts 1 and 5).

### Example 2

### Effect of Number of Passes on Gamma

This example shows the effect of the number of passes (number of times a fiber web was sprayed with CO₂) on the gamma value. The gamma value was used as an indication of the amount of charge on the fiber web, as gamma generally increases with an increase in charge.

The samples were uncharged meltblown fiber webs (handsheets) formed of polypropylene fibers having an average fiber diameter of about 2 microns. The samples had a basis weight of 25 gsm and a thickness of 8 mils. The samples were passed 2 or 4 times through a CO₂ charging apparatus having a configuration substantially similar to that shown in FIG. 1. The opposite side of the sample was exposed to the nozzle of the charging apparatus after each pass. After CO₂ spray treatment, the samples were dried at 70° C. for 3 minutes. Results of the experiments are shown in Table 2.

TABLE 2
Effect of number of pass on gamma

| | | | CO₂ | | | | |
|---|---|---|---|---|---|---|---|
| | | Belt | Release | | | | |
| | DCD | Speed | Pressure | No. of | Resistance | Penetration | |
| | (inches) | (ft/min) | (psi) | Passes | (mm H₂O) | (%) | Gamma |
| Control | | | | | 2.7 | 67.0 | 6.1 |
| Expt 1 | 2 | 5 | 50 | 2 | 2.4 | 16.5 | 32.6 |
| Expt 2 | 4 | 5 | 50 | 2 | 2.4 | 12.6 | 38.3 |
| Expt 3 | 2 | 10 | 50 | 2 | 2.4 | 11.7 | 39.3 |
| Expt 4 | 4 | 10 | 50 | 2 | 2.3 | 19.3 | 30.8 |
| Expt 5 | 2 | 5 | 150 | 2 | 2.3 | 11.3 | 40.8 |
| Expt 6 | 4 | 5 | 150 | 2 | 2.3 | 11.6 | 41.1 |
| Expt 7 | 2 | 10 | 150 | 2 | 2.4 | 22.2 | 27.8 |
| Expt 8 | 4 | 10 | 150 | 2 | 2.3 | 23.1 | 28.3 |
| Expt 9 | 2 | 5 | 50 | 4 | 2.3 | 11.3 | 40.8 |
| Expt 10 | 4 | 5 | 50 | 4 | 2.3 | 7.0 | 50.2 |
| Expt 11 | 2 | 10 | 50 | 4 | 2.3 | 7.2 | 49.2 |
| Expt 12 | 4 | 10 | 50 | 4 | 2.3 | 12.5 | 39.7 |
| Expt 13 | 2 | 5 | 150 | 4 | 2.2 | 11.2 | 44.3 |
| Expt 14 | 4 | 5 | 150 | 4 | 2.2 | 12.1 | 42.7 |
| Expt 15 | 2 | 10 | 150 | 4 | 2.2 | 17.7 | 34.2 |
| Expt 16 | 4 | 10 | 150 | 4 | 2.2 | 10.0 | 45.4 |
| Expt 17 | 3 | 7.5 | 100 | 2 | 2.2 | 16.5 | 35.2 |
| Expt 18 | 3 | 7.5 | 100 | 4 | 2.1 | 13.5 | 41.4 |

To further validate the effect of number of passes on gamma, the samples were passed through the charging apparatus with process parameter settings of 50 psi CO₂ release pressure, 10 ft/min belt speed and 3.5″ DCD. Results of the experiments are shown in Table 3.

TABLE 3
Effect of number of passes on gamma value

| | Resistance | Penetration | |
|---|---|---|---|
| | (mm H₂O) | (%) | Gamma |
| Control | 2.4 | 68.1 | 6.8 |
| CO2 1 Pass | 2.1 | 11.4 | 44.3 |
| CO2 2 Pass | 2.2 | 3.8 | 66.2 |
| CO2 3 Pass | 2.2 | 7.6 | 52.2 |
| CO2 4 Pass | 2.2 | 4.2 | 61.8 |

### Example 3

### Effect of Corona Pre-Charging on Gamma

This example shows the effect of pre-charging a fiber web on the gamma value. The gamma value was used as an indication of the amount of charge on the fiber web, as gamma generally increases with an increase in charge.

The samples were first subjected to DC and AC corona charging. The samples were meltblown fiber webs (handsheets) formed of polypropylene fibers having an average fiber diameter of about 2 microns. The samples had a basis weight of 25 gsm and a thickness of 8 mils. The samples were passed through a CO₂ charging apparatus having a configuration substantially similar to that shown in FIG. 1, with process parameter settings of 50 psi CO₂ release pressure, 10 ft/min belt speed and 3.5″ DCD. The opposite side of the sample was exposed to the nozzle of the charging apparatus after each pass. After CO₂ spray treatment, the samples were dried at 70° C. for 3 minutes. The control was subjected to DC and AC corona charging but not to CO₂ charging or drying. Results of the experiments are shown in Table 4.

TABLE 4
Effect of corona pre-charged fiber webs on CO₂ spray charging

| | Resistance | Penetration | |
|---|---|---|---|
| | (mm H₂O) | (%) | Gamma |
| Control | 2.3 | 2.2 | 71.5 |
| CO2 1 Pass | 2.0 | 2.4 | 81.4 |
| CO2 2 Pass | 2.0 | 1.5 | 91.8 |
| CO2 3 Pass | 2.1 | 1.6 | 86.6 |
| CO2 4 Pass | 2.0 | 1.8 | 87.1 |

The experimental results show that CO₂ spray charging can be used to further charge pre-corona charged media.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of charging a fiber web, comprising:
providing a source of a substantially non-polar substance, wherein the substantially non-polar substance is held in a container that includes a mechanism for releasing the substantially non-polar substance from the container;
releasing the substantially non-polar substance from the container;
passing the substantially non-polar substance through a fiber web from a first side to a second side of the fiber web; and
drawing at least a portion of the substantially non-polar substance into a vacuum apparatus positioned at the second side of the fiber web.

2. The method of claim 1, wherein the source of the substantially non-polar substance comprises a gas.

3. The method of claim 1, wherein the source of the substantially non-polar substance comprises a compressed fluid.

4. The method of claim 1, wherein the source of the substantially non-polar substance comprises a supercritical fluid.

5. The method of claim 1, wherein the source of the substantially non-polar substance comprises a liquid.

6. The method of claim 1, wherein the source of the substantially non-polar substance comprises a liquid that converts to a gas and/or a solid during the releasing step.

7. The method of claim 1, wherein the substantially non-polar substance is released from the container at a pressure of greater than or equal to about 25 psi and less than about 500 psi.

8. The method of claim 1, wherein the substantially non-polar substance passing through the fiber web comprises solid particles.

9. The method of claim 1, wherein the substantially non-polar substance passing through the fiber web comprises solid carbon dioxide.

10. The method of claim 1, comprising passing a mixture of substantially non-polar substances through the fiber web.

11. The method of claim 10, wherein the mixture of substantially non-polar substances comprises substances having the same phase.

12. The method of claim 10, wherein the mixture of substantially non-polar substances comprises substances having different phases.

13. The method of claim 1, wherein the substantially non-polar substance has a triple point of less than about −5° C.

14. The method of claim 1, wherein the substantially non-polar substance passing through the fiber web comprises a gas.

15. The method of claim 14, wherein the substantially non-polar substance comprises at least one of argon gas, nitrogen gas, helium gas and neon gas.

16. The method of claim 14, wherein the substantially non-polar substance comprises at least one of oxygen gas, hydrogen gas, and gaseous carbon dioxide.

17. The method of claim 1, wherein the container is connected to a nozzle comprising a nozzle lip for releasing the substantially non-polar substance from the container, wherein the vacuum apparatus comprises a vacuum slot for drawing the substantially non-polar substance into the vacuum apparatus, and wherein a distance between the nozzle lip and the first side of the fiber web is greater than about 1 inch and less than or equal to about 15 inches.

18. The method of claim 1, wherein the container is connected to a nozzle comprising a nozzle lip for releasing the substantially non-polar substance from the container, wherein the vacuum apparatus comprises a vacuum slot for drawing the substantially non-polar substance into the vacuum apparatus, and wherein a distance between the nozzle lip and the first side of the fiber web is greater than about 2 inches and less than or equal to about 10 inches.

19. The method of claim 1, wherein the container is connected to a nozzle comprising a nozzle lip for releasing the substantially non-polar substance from the container, wherein the vacuum apparatus comprises a vacuum slot for drawing the substantially non-polar substance into the vacuum apparatus, and wherein a distance between the nozzle lip and the first side of the fiber web is greater than about 4 inches and less than or equal to about 8 inches.

20. The method of claim 1, wherein the container is connected to a nozzle for releasing the substantially non-polar substance from the container, wherein the vacuum apparatus comprises a vacuum slot for drawing the substantially non-polar substance into the vacuum apparatus, and wherein the vacuum slot is positioned underneath the nozzle.

21. The method of claim 1, wherein the vacuum apparatus is operated at a level of greater than or equal to about 1 inches and less than about 20 inches of mercury.

22. The method of claim 1 comprising forming a fiber web having a −log [(NaCl penetration %/100)/pressure drop, mm H₂O]×100 value of at least 12, measured using NaCl particles approximately 0.26 microns in diameter at a media face velocity of approximately 5.3 cm/sec.

23. The method of claim 1, wherein the fiber web, prior to the releasing step, has been subjected to a corona charging process.

24. The method of claim 1, wherein the fiber web, prior to the releasing step, is uncharged.

25. The method of claim 1 comprising drawing greater than or equal to 50% of the substantially non-polar substance released from the container into the vacuum apparatus.

26. The method of claim 1 further comprising passing a substantially non-polar substance through the fiber web from the second side to the first side of the fiber web.

27. The method of claim 1, wherein the container is connected to a first nozzle for releasing the substantially non-polar substance from the container, the method comprising passing the fiber web across the first nozzle, the method further comprising passing the fiber web across a second nozzle connected to a container.

28. A method of charging a fiber web, comprising:
providing a source of carbon dioxide;
passing the carbon dioxide through a fiber web from a first side to a second side of the fiber web; and
drawing at least a portion of the carbon dioxide into a vacuum apparatus positioned at the second side of the fiber web,
wherein the fiber web is exposed to the atmosphere during the passing step.

29. The method of claim 28, wherein the substantially non-polar substance is discharged from the container at a pressure of between about 50 psi and about 100 psi.

30. The method of claim 28, wherein the source of carbon dioxide comprises a liquid.

31. The method of claim 28, wherein the source of carbon dioxide comprises a gas.

32. The method of claim 28, wherein the carbon dioxide passing through the fiber web comprises dry ice.

33. The method of claim 28, wherein the carbon dioxide passing through the fiber web comprises liquid carbon dioxide.

34. The method of claim 28, wherein the carbon dioxide passing through the fiber web comprises gaseous carbon dioxide.

35. The method of claim 28, wherein the container is connected to a nozzle for releasing the substantially non-polar substance from the container, wherein the vacuum apparatus comprises a vacuum slot for drawing the substantially non-polar substance into the vacuum apparatus, and wherein a distance between the nozzle and the vacuum slot is between 1 and 15 inches.

36. The method of claim 28, wherein the container is connected to a nozzle for releasing the substantially non-polar substance from the container, wherein the vacuum apparatus comprises a vacuum slot for drawing the substantially non-polar substance into the vacuum apparatus, and wherein the vacuum slot is positioned underneath the nozzle.

37. A method of charging a fiber web, comprising:
transporting a fiber web across a charging apparatus, wherein the charging apparatus comprises a source of a substantially non-polar substance, the substantially non-polar substance being held in a container that includes a mechanism for releasing the substantially non-polar substance from the container;
releasing the substantially non-polar substance from the container; and
passing the substantially non-polar substance through a fiber web from a first side to a second side of the fiber web during the transporting step.

38-48. (canceled)
